(19) United States
(12) Patent Application Publication
(10) Pub. No.: US 2006/0103623 A1
(43) Pub. Date: May 18, 2006

(54) Method and apparatus to enter text in a phone dialer entry field

(75) Inventor: Scott Davis, North Vancouver (CA)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/990,049

(22) Filed: Nov. 15, 2004

(51) Int. Cl. G09G 5/00; H04M 11/00

(52) U.S. Cl. 345/156; 379/93.18

(57) ABSTRACT

Disclosed herein are methods and apparatus to dial a telephone number that includes at least one numeric symbol and at least one non-numeric symbol. The method includes, in response to a user entering a numeric symbol, entering the numeric symbol into a telephone number buffer; in response to the user entering a non-numeric symbol, converting the non-numeric symbol into a corresponding numeric symbol in accordance with a telephone keypad numeric symbol to non-numeric symbol mapping function and entering the corresponding numeric symbol into a telephone number buffer.

### TECHNICAL FIELD:

The presently preferred embodiments of this invention relate generally to user interfaces and, more specifically, relate to graphical user interface apparatus and methods usable with communication terminals that include a telephone dialer functionality.

### BACKGROUND:

Many telephone and multifunction devices use a touchscreen and a graphical user interface (GUI) to present a virtual ITU-T (International Telecommunication Union-Telecommunication Standardization Sector) keypad for phone dialing. In this case such devices do not have physical keys for dialing a phone number. Touchscreen devices may also employ virtual keyboards and/or handwriting recognition for text entry.

The ITU-T keypad associates letters of the alphabet with the numbers of the keypad. Depending on the particular implementation, and by example, the number ‘2’ key carries the letters ABC, the number ‘3’ key carries the letters DEF, etc., as is well known. As is also well known, some companies use telephone numbers that spell words related to their business, such as 1-800-Flowers. Currently, if a user wishes to dial a phone number that uses a word as part of the phone the number, the user must find the digit corresponding to the letter in the word using the ITU-T keypad, or memorize the associations of words and numbers on the ITU-T keypad. For example, if the user wishes to dial 1-800-Flowers, the user must search for the numbers that correspond to the letters F-L-O-W-E-R-S on the phone keypad (e.g., 3-5-6-9-3-7-7). Alternatively, the user may memorize the associations of letters and numbers on the keypad. However, either approach can require a significant amount of time to enter the telephone number and can also be error prone, thereby resulting in an increased probability that the user will dial a wrong number.

### SUMMARY OF THE PREFERRED EMBODIMENTS

The foregoing and other problems are overcome, and other advantages are realized, in accordance with the presently preferred embodiments of this invention.

In one aspect thereof this invention provides a user interface that includes a touch sensitive display screen coupled to a controller operable to display on the touch sensitive display screen a first key entry virtual device comprised of numeric symbol keys and a second key entry virtual device comprised of non-numeric symbol keys for a user to enter information. The controller is further operable to receive a non-numeric symbol entered by the user on the second key entry virtual device and to convert the non-numeric symbol to a numeric symbol in accordance with a first key entry device non-numeric symbol to numeric symbol mapping function.

In another aspect thereof this invention provides a mobile station that has a radio frequency transceiver coupled to a controller, and a user interface coupled to the controller. The user interface includes a touch sensitive display screen operable to display a virtual telephone keypad comprised of numeric symbol keys and a virtual keyboard comprised of non-numeric symbol keys. The controller is operable to receive a non-numeric symbol as part of a telephone number and to convert the non-numeric symbol to a numeric symbol in accordance with a virtual telephone keypad non-numeric symbol to numeric symbol mapping function.

In another aspect thereof this invention provides a method to dial a telephone number that is comprised of at least one numeric symbol and at least one non-numeric symbol. The method includes, in response to a user entering a numeric symbol, entering the numeric symbol into a telephone number buffer; in response to the user entering a non-numeric symbol, converting the non-numeric symbol into a corresponding numeric symbol in accordance with a telephone keypad numeric symbol to non-numeric symbol mapping function and entering the corresponding numeric symbol into a telephone number buffer.

In a still further aspect thereof this invention provides a storage medium tangibly embodying a program of machine-readable instructions executable by a digital processing apparatus to perform operations to dial a telephone number. The operations include, in response to a user entering a numeric symbol, entering the numeric symbol into a telephone number buffer; in response to the user entering a non-numeric symbol, converting the non-numeric symbol into a corresponding numeric symbol in accordance with a telephone keypad numeric symbol to non-numeric symbol mapping function and entering the corresponding numeric symbol into a telephone number buffer.

In another aspect thereof this invention provides a telephone device that includes a controller that is responsive to a user entering a numeric symbol via a virtual telephone keypad to store the numeric symbol. The telephone device further includes means for entering a non-numeric symbol. The controller is further responsive to the user entering a non-numeric symbol via the non-numeric symbol entry means to convert the non-numeric symbol into a corresponding numeric symbol in accordance with a virtual telephone keypad numeric symbol to non-numeric symbol mapping function and to store the corresponding numeric symbol.

In a further aspect thereof this invention provides a dialer user interface that includes a first input device coupled to a controller and operable to enter numeric symbols and a second input device coupled to the controller and operable to enter at least non-numeric symbols. The controller is operable to convert an entered non-numeric symbol to a numeric symbol in accordance with a non-numeric symbol to numeric symbol mapping function to provide a telephone number to be dialed.

In another aspect thereof this invention provides a user interface that comprises numeric symbol entry means and non-numeric symbol entry means coupled to a controller. The controller operates under control of a program to receive an entered non-numeric symbol and to convert the entered non-numeric symbol to a corresponding numeric symbol in accordance with a non-numeric symbol to numeric symbol mapping function. The controller has an output coupled to a telephone number dialer function for outputting the corresponding numeric symbol to the telephone number dialer function.

In a still further aspect thereof this invention provides a dialer user interface that includes an input device coupled to a controller operable to enter at least non-numeric symbols. The controller is operable to convert an entered non-numeric symbol to a numeric symbol in accordance with a non-numeric symbol to numeric symbol mapping function to provide at least a part of a telephone number.

In a still further aspect thereof this invention provides a software product that comprises program instructions readable by a data processor for causing the data processor to implement a dialer user interface that is operable to receive at least non-numeric symbols and to convert a received non-numeric symbol to a numeric symbol in accordance with a non-numeric symbol to numeric symbol mapping function to thereby provide at least a part of a telephone number.

### BRIEF DESCRIPTION OF THE DRAWINGS

The foregoing and other aspects of the presently preferred embodiments of this invention are made more evident in the following Detailed Description of the Preferred Embodiments, when read in conjunction with the attached Drawing Figures, wherein:

FIG. 1 is simplified block diagram of a wireless communications terminal, and an exemplary wireless network, that is suitable for use in implementing the preferred embodiments of this invention;

FIG. 2 depicts a virtual keyboard displayed with a virtual keypad for enabling a user to enter alphabetic characters while dialing, in accordance with the preferred embodiments of this invention;

FIG. 3 is a logic flow diagram that depicts the operation of the microcontrol unit (MCU) of FIG. 1 when executing a stored program in accordance with the preferred embodiments of this invention;

FIG. 4 shows the correspondence between alphabetic letters and number keys for a plurality of different types of conventional touch tone keypads;

FIG. 5 is a simplified block diagram of a dialer user interface in accordance with embodiments of this invention; and

FIG. 6 shows an alternate embodiment of an entered telephone number field.

### DETAILED DESCRIPTION OF THE PREFERRED EMBODIMENTS

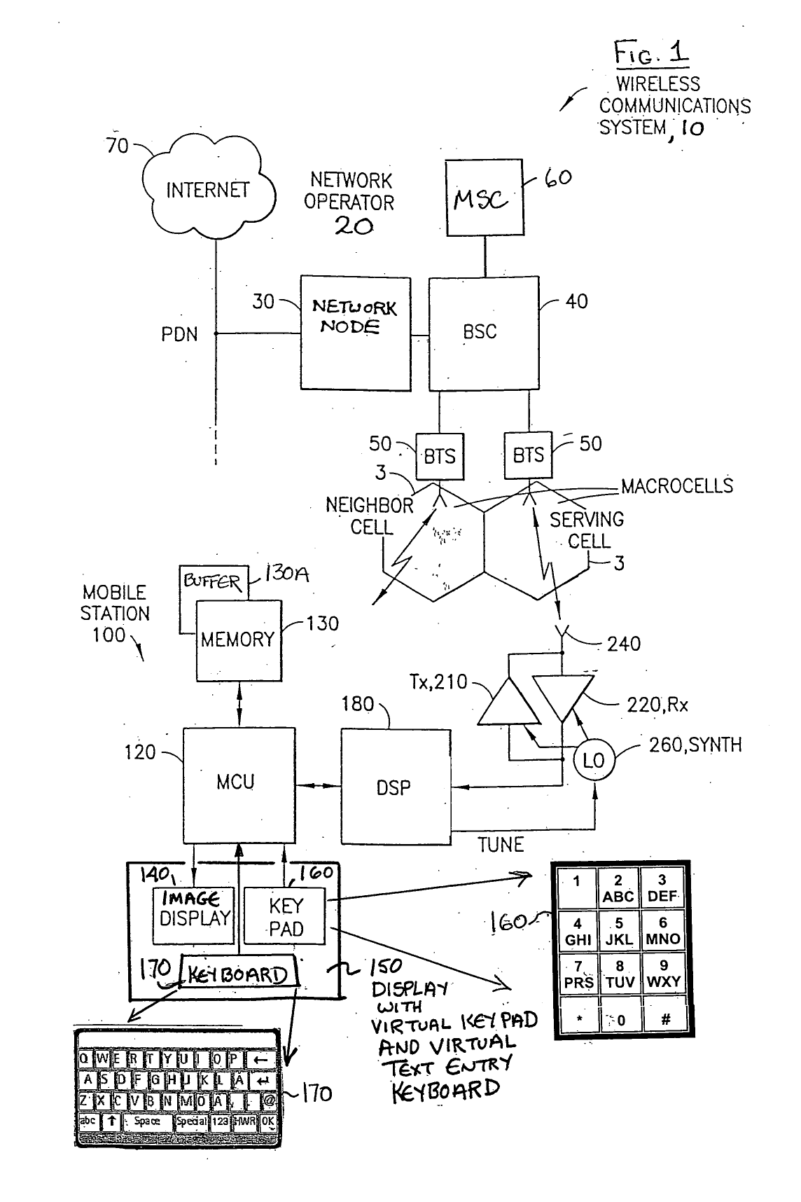

By way of introduction, and referring to FIG. 1, there is shown in a simplified block diagram an embodiment of a wireless communications system 10 that includes a wireless communications terminal, also referred to for convenience as a mobile station (MS) 100, that is suitable for practicing this invention. An exemplary network operator 20 has, for example, a node 30 for connecting to a telecommunications network, such as a Public Packet Data Network or PDN, at least one base station controller (BSC) 40 or equivalent apparatus, and a plurality of base transceiver stations (BTS) 50, also referred to as base stations (BSs), that transmit in a forward or downlink direction both physical and logical channels to the MS 100 in accordance with a predetermined air interface standard. A reverse or uplink communication path also exists from the MS 100 to the network operator 20, which conveys mobile-originated access requests and traffic. A cell 3 is associated with each BTS 50, where one cell will at any given time be considered to be a serving cell, while an adjacent cell(s) will be considered to be a neighbor cell.

For the purposes of this invention the air interface standard can conform to any suitable standard or protocol, and may enable both voice and data traffic, such as data traffic enabling Internet 70 access and web page downloads, as well as Voice Over Internet Protocol (VOIP) calls to be made. Typically the network operator 20 will include a mobile switching center (MSC) 60 for enabling conventional voice telephone calls to be made.

The MS 100 typically includes a control unit or control logic, such as a data processor embodied as a microcontrol unit (MCU) 120. The MCU 120 has an output coupled to an input of a display 150 and an input coupled to an output of a keypad 160. In the presently preferred embodiments of the invention the display 150 is a touch sensitive display, and the keypad 160 is a displayed or virtual keypad, i.e., one that is displayed to the user such that the user, by touching the surface of the display 150, is enabled to enter desired numbers, as when dialing a telephone number. In the presently preferred embodiments of this invention there can also be a displayed or virtual keyboard 170, such as one that resembles a conventional QWERTY keyboard. In this case the user enters alphabetic letters or symbols (based on the Roman alphabet or any desired alphabet), again by touching the touch sensitive surface of the display 150 at a location that corresponds to a symbol to be entered. Also shown is an image display 140, which can be understood to be any type of conventional image and/or graphical display, such as one that shows a user digital photographs taken by a camera (not shown) of the MS 100, or image and/or textual data downloaded from the Internet 70. The image display 140, the virtual keypad 160 and the virtual keyboard 170 may all be simultaneously shown on the display 150, or they may be presented individually or in any combination. The control of the display 150, which may be referred to as a graphical user interface (GUI), may be the responsibility of the MCU 120, under the control of computer program instructions or software stored in a memory 130. At least some of this software is software that is executed to implement the methods in accordance with embodiments of this invention.

In general, the various embodiments of the MS 100 can include, but are not limited to, cellular telephones, personal digital assistants (PDAs) having a telephone dialer function, portable computers having a telephone dialer function, image capture devices such as digital cameras, gaming devices, music storage and playback appliances having a telephone dialer function, Internet appliances permitting Internet access and browsing and having a telephone dialer function, as well as portable units or terminals that incorporate combinations of such functions.

It should be noted that the embodiments of this invention can be used with either wireless or wired user terminals and devices. For example, a desktop telephone device connected to a local or a remote telephone switch through wiring, and that has a touch sensitive screen implementing a GUI, may benefit from the use of teachings of this invention.

The memory 130 can include non-volatile memory for storing an operating program and other information, as well as a volatile memory for temporarily storing required data, scratchpad memory, received packet data, packet data to be transmitted, and the like. At least some of this temporary data can be stored in a data buffer 130A, such as a telephone number buffer that stores a telephone number as it is dialed by the user, prior to sending the telephone number to the network 20. The operating program is assumed, for the purposes of this invention, to enable the MCU 120 to execute the software routines, layers and protocols required to implement the methods in accordance with this invention, as was noted above, as well as to handle the overall operation of the MS 100. Although not shown, a microphone and speaker are typically provided for enabling the user to conduct voice calls in a conventional manner. The operating program of the MS 100 may also implement a voice recognition function and/or a handwriting recognition function whereby the user draws characters on the touch screen 150 that are converted to alphanumeric characters.

In other embodiments a specialized controller data processor and related memory may be dedicated to operating the GUI. However, in this case the dedicated data processor will still operate in accordance with a stored software program that is designed and constructed in accordance with the embodiments of this invention.

The MS 100 is assumed to also contain a wireless section that includes a digital signal processor (DSP) 180, or equivalent high speed processor or logic, as well as a wireless transceiver that includes a transmitter 200 and a receiver 220, both of which are coupled to an antenna 240 for communication with the network operator. At least one local oscillator, such as a frequency synthesizer (SYNTH) 260, is provided for tuning the transceiver. Data, such as dialed telephone numbers, digitized voice and packet data, is transmitted and received through the antenna 240.

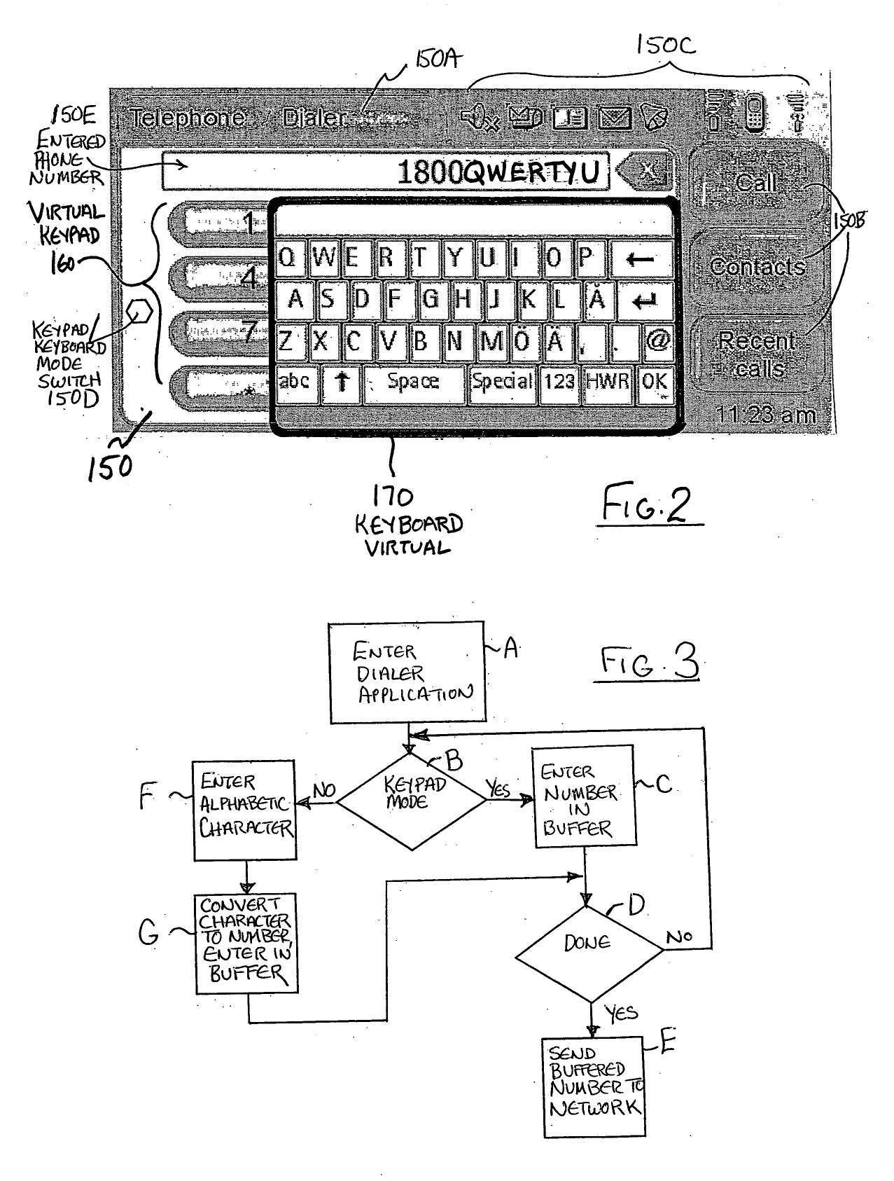

The presently preferred embodiments of this invention will now be more fully described with reference to FIGS. 2 and 3, where FIG. 2 depicts the virtual keyboard 170 displayed with the virtual keypad 160 for enabling a user to enter alphabetic characters while dialing, in accordance with the preferred embodiments of this invention, and where FIG. 3 shows a logic flow diagram that depicts the operation of the MCU 120 when executing a program stored in the memory 130, in accordance with the preferred embodiments of this invention.

The display 150 as shown in this non-limiting example is assumed to be simultaneously displaying an identification 150A of a currently running application, in this case a ‘Telephone Dialer’ application, and at least one ‘soft’ button 150B that may be associated with the currently running application, and that when touched invokes some response, such as displaying a list of Contacts or Recent Calls, or Calling the displayed telephone number 1 50E that has been entered (dialed) by the user. The display 150 may also show a plurality of icons 150C representing functions that are related to, or that are unrelated to, the currently running application (the Telephone Dialer application in this example).

In accordance with an aspect of the teachings of this invention, the display 150 may also display a soft button or switch 150D associated with a Telephone Dialer Keypad/Keyboard mode. For example, assume that the user is dialing a numeric telephone number using the displayed virtual keypad 160, and that only the virtual keypad 160 is displayed to the user. The user then wishes to enter an alphabetic or other symbol or symbols (such as F-L-O-W-E-R-S), referred to herein for convenience as non-numeric symbols to distinguish them from numeric symbols (e.g., 1-8-0-0). To accomplish this the user touches the mode switch 150D, causing the virtual keyboard 170 to be displayed, either on top of the virtual keypad 160 (as shown) or in place of the virtual keypad 160. In either case, the user then enters the desired non-numeric symbol(s) on the virtual keyboard 170, without regard for their underlying numeric significance in so far as the telephone dialer keypad 160 is concerned. Touching the mode switch 1 50D again causes the display 150 to revert to displaying the virtual keypad 160. Thus, the mode switch 150D may be considered to be a toggle switch type of function to toggle the graphical user interface between the virtual keypad 160 and the virtual keyboard 170.

In other embodiments the displayed virtual toggle switch 150D could be replaced by the user speaking some predetermined command to a voice recognition function of the MS 100, or even with a physical hardware switch.

It is also within the scope of the embodiments of this invention to simultaneously display both the virtual keypad 160 and the virtual keyboard 170; however due to the typically small size of the display screen for portable, handheld terminals this may not be desirable from a user convenience viewpoint.

Note that while the displayed entered telephone number 150E in FIG. 2 shows both the numeric and non-numeric symbols that are entered by the user, the software executed by the MCU 120 automatically converts non-numeric symbols to the corresponding numeric symbols as dictated by the layout of the virtual keypad 160. For example, and referring to the keypad 160 mapping shown in FIG. 1, the user entering the string of non-numeric symbols ‘N-0-K-I-A’ would result in the MCU 120 automatically converting the entered symbols to the string of corresponding numeric symbols: ‘6-6-5-4-2’. This can be done, as non-limiting examples, algorithmically, or by using a table lookup procedure. The corresponding numeric symbols, and any numeric symbols entered directly by the user on the keypad 160, can be stored in a buffer, such as the buffer 130A shown in FIG. 1, until the user touches an appropriate key, such as the ‘Call’ key 150B shown in FIG. 2. At this time the buffered telephone number is transmitted to the network operator 20 in a conventional manner for the type of call that the user is initiating. Note that in other embodiments the entered telephone number may not be buffered, and it may instead be transmitted directly to the network operator 20 as it is entered by the user.

It should be noted that the entered telephone “number” could be composed of all non-numeric symbols, or of a mixture of numeric symbols and at least one non-numeric symbol.

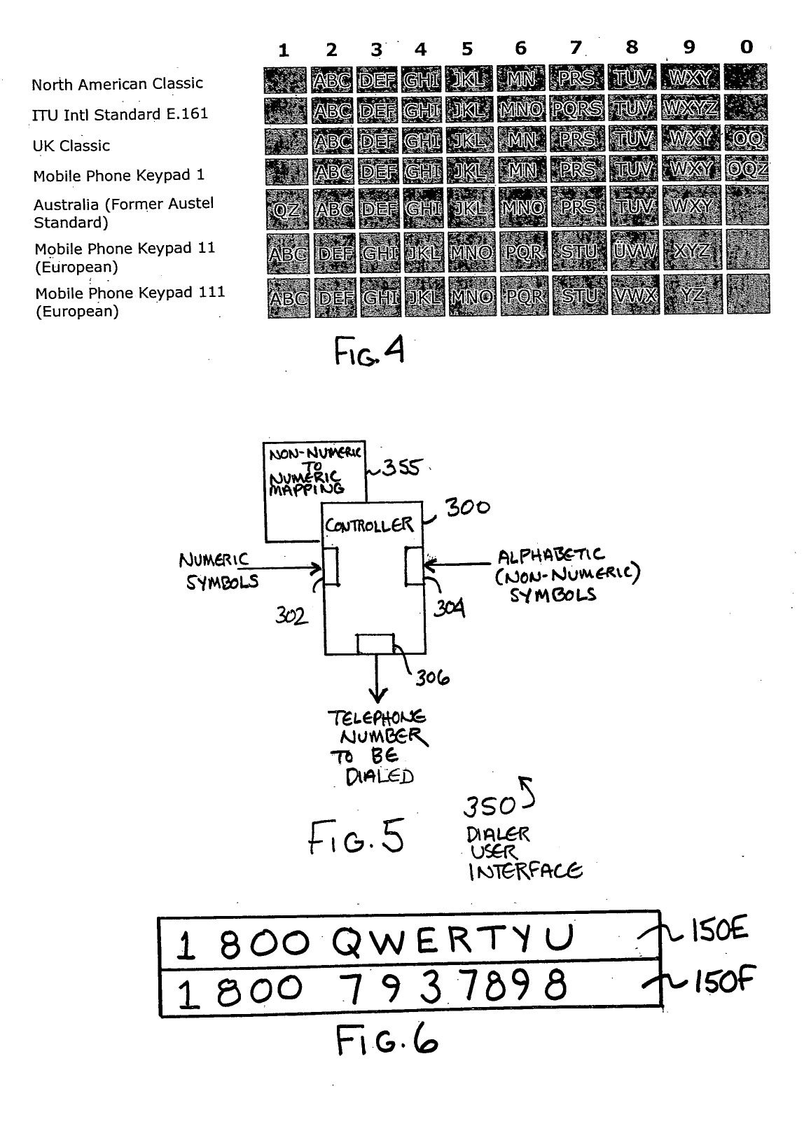

FIG. 6 shows an alternate embodiment of the entered telephone number field wherein the entered phone number 150E is as was shown in FIG. 2, while an additional field 150F shows the user the result of the mapping operation. In this case the user is shown the telephone number that was entered by the user (1 50E) and the corresponding all numeric equivalent thereof (150F) as output from the non-numeric to numeric mapping function. In this case the mapping is based on the ITU International Standard E. 161 (see FIG. 4), which is but one example of a number of possible mappings.

It can be appreciated that the virtual keyboard 170 may be used by a number of applications, in addition to the Telephone Dialer application in accordance with the teachings of this invention, such as for conventional text entry applications. Conventional text entry applications can include, but need not be limited to, composing short message service (SMS) messages, Internet browsing and searching, and word processing. Thus, it may not be necessary to design or modify any already present virtual keyboard 170 software modules and drivers to implement this invention, nor for that matter it may not be necessary to design or modify any already present virtual keypad 160 software modules and drivers to implement this invention. Instead, the normal virtual keypad 160 software can be called and used when the Keypad/Keyboard toggle switch 150D in the Keypad mode, and the normal virtual keyboard 170 software can be called and used when the Keypad/Keyboard toggle switch 150D in the Keyboard mode. The output of the virtual keyboard 170 software is, however, processed so as to correlate the output non-numeric symbol, as entered by the user, with the corresponding numeric symbol, depending on the style of keypad 160 that is in use and the mapping between keypad keys and non-numeric symbols.

Further in this regard, FIG. 4 shows the correspondence between the numeric keys and alphabetic characters for a plurality of different types of touch tone keypads. It is assumed for the purposes of this invention that the software module that performs the actual mapping from the symbol entered on the virtual keyboard 170 to the corresponding number on the virtual keypad 160, such as the block G in FIG. 3 as described below, has knowledge of which particular style of virtual keypad 160 that the GUI is emulating. Should the type of keypad change (e.g., from the Mobile Phone Keypad 1 to the Mobile Phone Keypad 111), the mapping software module changes the mapping of letters to numbers accordingly. For the purposes of this invention, FIG. 4 is assumed to illustrate examples of seven different (and non-limiting) keypad non-numeric symbol to numeric symbol mapping functions, only one of which would typically be in effect at any given time within the MS 100. The illustrated examples include the North American Classic, ITU International Standard E. 161 (mentioned above with respect to FIG. 6), UK Classic, Mobile Phone Keypad 1, Australia (former Austel Standard), Mobile Phone Keypad 11 (European) and Mobile Phone Keypad 111 (European). These seven are not intended to represent an exhaustive list of all possible types of keypads.

Turning now to FIG. 3, at block A it is assumed that the user launches, by whatever means, the ‘Dialer Application’ of the MS100. The software then loops until the entire telephone number is entered by, at block B, determining if the software is in the keypad mode or the keyboard mode (based on the state of logical toggle switch 1 50D). If in the keypad mode, at block C the software accepts an entered numeric symbol from the virtual keypad 160 and enters it into the buffer 130A. Control then passes to block D to determine if the telephone number has been completely entered, by whatever means, such as by the user touching the Call soft key 150B. If it is determined that the entire telephone number has been entered, at block E the buffered telephone number is sent to the network operator 20 to initiate the call. If the complete telephone number has not yet been entered, control passes back to block B to make a determination as to whether the user has toggled the switch 150D to the keyboard mode. If the user has, it is assumed that the software has detected this and displayed the virtual keyboard 170 to the user, as in FIG. 2. A non-numeric symbol (such as an alphabetic character) is then entered at block F via the virtual keyboard 170. At block G the software converts the non-numeric symbol to a corresponding numeric symbol based on a currently used type of keypad 160 (see FIG. 4), and enters the corresponding numeric symbol into the buffer 130A. This can be accomplished by the above-noted algorithmic or table lookup procedure. Control then passes to block D to determine if the complete telephone number has been entered, and the processing continues as was described above. In this manner the telephone number is assembled in the buffer 1 30A as the user enters it, and as a correctly formatted numeric string, even though the user may be entering one or more non-numeric symbols as part of the telephone “number”.

While described in the context of entering a telephone number when making a call, it can be appreciated that this procedure can be used as well to enter a telephone number to be stored into a phone book or other application that stores telephone numbers. In this case the telephone number could be stored as numeric symbols, but displayed to the user as a combination of numeric and non-numeric symbols. Alternatively, the telephone number could be stored as a combination of numeric and non-numeric symbols, and when selected by the user the telephone “number” string can be played through the method shown in FIG. 3 to make the conversion of the non-numeric symbols to numeric symbols. In this case the keypad/keyboard mode determination (block B) can be based on whether a current symbol being processed in the symbol string is a numeric or a non-numeric symbol.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims.

As but some examples, the use of the virtual keyboard 170 may be replaced or augmented by the use of a voice recognition function where the user speaks a non-numeric symbol that is recognized and then converted to the corresponding numeric symbol, or by a handwriting recognition function where the user writes, such as on the touch sensitive display screen 150, a non-numeric symbol that is recognized and then converted to the corresponding numeric symbol.

Further, while the virtual keypad 160 and the virtual keyboard 170 were shown as being implemented with the touch sensitive display screen 150, in other embodiments one or both of these data entry devices may be implemented by a projector system that projects an image of the keypad and/or keyboard onto a surface, and that comprises means for detecting where the user touches the projected displayed keypad and/or keyboard to enter the corresponding numeric or non-numeric symbol.

Further, it can be appreciated that the embodiments of this invention encompass the entry of text by whatever means, such as with a traditional (physical) keyboard, or with a miniature “thumb” keyboard such as those found on some personal digital assistant devices.

Still further, the embodiments of this invention encompass the dialing of a number from any text string that is recognized to be, or that is represented as being, a telephone number, such as with the virtual phone dialer interface or, as non-limiting examples, from a text string obtained from a word processing document or a spreadsheet document. The text string may be entered manually by a user, or it may be entered automatically by a computer through a suitable text string interface, where the text string comprises numeric and alphabetic symbols, or comprises only non-numeric symbols.

Further in this regard, FIG. 5 is a simplified block diagram of a dialer user interface 350 in accordance with embodiments of this invention. The dialer user interface 350 includes a first input device/interface 302 coupled to a controller 300 and operable to enter numeric symbols, and further includes a second input device/interface 304 coupled to the controller 300 and operable to enter at least non-numeric symbols. The controller 350 is operable to convert an entered non-numeric symbol to a numeric symbol in accordance with a non-numeric symbol to numeric symbol mapping function 355 to provide at an output interface 306 a telephone number to be dialed. In some embodiments the functionality of the interfaces 302, 304 may be combined into one interface, while in other embodiments only the non-numeric symbol interface 304 may be present or used.

Various embodiments of this invention thus may be seen to provide a user interface having numeric symbol entry means and non-numeric symbol entry means that are coupled to the controller 300. The controller 300 operates under control of a program to receive an entered non-numeric symbol and to convert the entered non-numeric symbol to a corresponding numeric symbol in accordance with the non-numeric symbol to numeric symbol mapping function 355. The controller 300 has an output coupled to a telephone number dialer function for outputting the corresponding numeric symbol to the telephone number dialer function. The numeric symbol entry means can comprise one of a physical or a virtual telephone touch tone keypad comprising number keys, and the non-numeric symbol entry means can comprise one of a physical or a virtual keyboard comprising alphabetic letter keys. At least one of the numeric symbol entry means and the non-numeric symbol entry means can comprise the touch sensitive screen of the display 150. The numeric symbol entry means and the non-numeric symbol entry means may both comprise the same touch sensitive screen, or they be provided by different touch sensitive screens. Further, at least one of the numeric symbol entry means and the non-numeric symbol entry means can comprise a physical key-based entry device, and the numeric symbol entry means and the non-numeric symbol entry means may both comprise the same physical key-based entry device, such as a keyboard having a set of alphabetic keys and a set of numeric keys. The user interface may comprise a part of a user terminal having a telephone functionality, where a telephone number is entered by a user as a combination of numbers and alphabetic characters, and where the telephone number dialer function outputs a string of numeric symbols to a telephone network operator. In a non-limiting embodiment the string of numeric symbols is sent to the telephone network operator using a wireless communication channel.

All such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. A user interface, comprising a touch sensitive display screen coupled to a controller operable to display on the touch sensitive display screen a first key entry virtual device comprised of numeric symbol keys and a second key entry virtual device comprised of non-numeric symbol keys for a user to enter information, said controller being further operable to receive a non-numeric symbol entered by the user on said second key entry virtual device and to convert said non-numeric symbol to a numeric symbol in accordance with a first key entry device non-numeric symbol to numeric symbol mapping function.

2. A user interface as in claim 1, where said first key entry virtual device corresponds to a telephone touch tone keypad, and where said second key entry virtual device corresponds to a keyboard having alphabetic letters.

3. A user interface as in claim 1, further comprising a switch for enabling the user to select for use one of said first key entry virtual device or said second key entry virtual device.

4. A user interface as in claim 1, further comprising a virtual switch displayed by said controller on said touch sensitive screen enabling the user to select for use one of said first key entry virtual device or said second key entry virtual device.

5. A user interface as in claim 1, where said first key entry virtual device corresponds to a telephone touch tone keypad, where said second key entry virtual device corresponds to a keyboard having alphabetic letters, and where said information comprises a telephone number that is entered by the user as a combination of numbers and letters.

6. A user interface as in claim 1, where said user interface comprises a part of a user terminal having a telephone functionality, where said first key entry virtual device corresponds to a telephone touch tone keypad, where said second key entry virtual device corresponds to a keyboard having alphabetic letters, and where said information comprises a telephone number that is entered by said user as a combination of numbers and letters, that is stored in said terminal and sent to a telephone network operator as a numeric string.

7. A user interface as in claim 6, where the numeric string is sent to the telephone network operator using a wireless communication channel.

8. A mobile station, comprising a radio frequency transceiver coupled to a controller, and a user interface coupled to said controller, said user interface comprising a touch sensitive display screen operable to display a virtual telephone keypad comprised of numeric symbol keys and a virtual keyboard comprised of non-numeric symbol keys, said controller being operable to receive a non-numeric symbol as part of a telephone number and to convert said non-numeric symbol to a numeric symbol in accordance with a virtual telephone keypad non-numeric symbol to numeric symbol mapping function.

9. A mobile station as in claim 8, further comprising a switch for enabling the user to select for use one of the virtual telephone keypad and the virtual keyboard.

10. A mobile station as in claim 9, where said switch comprises a virtual switch displayed on said touch sensitive screen.

11. A mobile station as in claim 8, further comprising a memory to store the telephone number prior to sending the stored telephone number via said transceiver to a telephone network operator as a numeric string.

12. A method to dial a telephone number comprised of at least one numeric symbol and at least one non-numeric symbol, comprising:
in response to a user entering a numeric symbol, entering the numeric symbol into a telephone number buffer;
in response to the user entering a non-numeric symbol, converting the non-numeric symbol into a corresponding numeric symbol in accordance with a telephone keypad numeric symbol to non-numeric symbol mapping function; and
entering the corresponding numeric symbol into a telephone number buffer.

13. A method as in claim 12, where the numeric symbol is entered via a virtual telephone keypad, and where the non-numeric symbol is entered via a virtual keyboard comprised of virtual keys having non-numeric legends.

14. A method as in claim 12, where the numeric symbol is entered via a virtual telephone keypad displayed on a touch sensitive display, and where the non-numeric symbol is entered via a virtual keyboard comprised of virtual keys having non-numeric legends that is displayed on the touch sensitive display.

15. A method as in claim 12, where the numeric symbol is entered via a virtual telephone keypad, and where the non-numeric symbol is entered via a handwriting recognition process.

16. A method as in claim 12, where the numeric symbol is entered via a virtual telephone keypad, and where the non-numeric symbol is entered via a speech recognition process.

17. A method as in claim 12, executed in cooperation with a data processor that comprises part of a mobile wireless telephone.

18. A method as in claim 12, further comprising displaying to a user entered numeric and non-numeric symbols.

19. A method as in claim 12, further comprising displaying to a user entered numeric symbols and corresponding numeric symbols output from the telephone keypad numeric symbol to non-numeric symbol mapping function.

20. A storage medium tangibly embodying a program of machine-readable instructions executable by a digital processing apparatus to perform operations to dial a telephone number, the operations comprising:
in response to a user entering a numeric symbol, entering the numeric symbol into a telephone number buffer;
in response to the user entering a non-numeric symbol, converting the non-numeric symbol into a corresponding numeric symbol in accordance with a telephone keypad numeric symbol to non-numeric symbol mapping function; and
entering the corresponding numeric symbol into a telephone number buffer.

21. A storage medium as in claim 20, where the numeric symbol is entered via a virtual telephone keypad, and where the non-numeric symbol is entered via a virtual keyboard comprised of virtual keys having non-numeric legends.

22. A storage medium as in claim 20, where the numeric symbol is entered via a virtual telephone keypad displayed on a touch sensitive display, and where the non-numeric symbol is entered via a virtual keyboard comprised of virtual keys having non-numeric legends that is displayed on the touch sensitive display.

23. A storage medium as in claim 20, where the numeric symbol is entered via a virtual telephone keypad, and where the non-numeric symbol is entered via a handwriting recognition process.

24. A storage medium as in claim 20, where the numeric symbol is entered via a virtual telephone keypad, and where the non-numeric symbol is entered via a speech recognition process.

25. A storage medium as in claim 20, where said data processing apparatus comprises part of a mobile wireless telephone.

26. A storage medium as in claim 20, further comprising an operation of displaying to a user entered numeric and non-numeric symbols.

27. A storage medium as in claim 20, further comprising an operation of displaying to a user entered numeric symbols and corresponding numeric symbols output from the telephone keypad numeric symbol to non-numeric symbol mapping function.

28. A telephone device, comprising a controller that is responsive to a user entering a numeric symbol via a virtual telephone keypad to store the numeric symbol; and means for entering a non-numeric symbol; said controller being further responsive to the user entering a non-numeric symbol via said non-numeric symbol entry means to convert the non-numeric symbol into a corresponding numeric symbol in accordance with a virtual telephone keypad numeric symbol to non-numeric symbol mapping function and to store the corresponding numeric symbol.

29. A telephone device as in claim 28, where said non-numeric symbol entry means is comprised of a virtual keyboard comprised of virtual keys having non-numeric legends.

30. A telephone device as in claim 28, where said virtual telephone keypad is displayed on a touch sensitive display, and where said non-numeric symbol entry means is comprised of a virtual keyboard comprised of virtual keys having non-numeric legends that is displayed on the touch sensitive display.

31. A telephone device as in claim 28, where said non-numeric symbol entry means is comprised of a handwriting recognition process.

32. A telephone device as in claim 28, where said non-numeric symbol entry means is comprised of a speech recognition process.

33. A dialer user interface, comprising a first input device coupled to a controller and operable to enter numeric symbols and a second input device coupled to the controller and operable to enter at least non-numeric symbols, said controller operable to convert an entered non-numeric symbol to a numeric symbol in accordance with a non-numeric symbol to numeric symbol mapping function to provide a telephone number to be dialed.

34. A dialer user interface as in claim 33, where said first input device comprises a display of a virtual keypad that comprises numeric keys, and where said second input device comprises a display of a virtual keyboard that comprises alphabetic keys.

35. A dialer user interface as in claim 33, where said first input device comprises a display of a virtual keypad that comprises numeric keys, and where said second input device comprises a keyboard that comprises alphabetic keys.

36. A dialer user interface as in claim 33, where said first input device comprises a display of a virtual keypad that comprises numeric keys, and where said second input device comprises an interface to a text string that comprises alphabetic symbols.

37. A dialer user interface as in claim 33, where said first input device and said second input device comprise an interface to a text string that comprises numeric and alphabetic symbols.

38. A user interface, comprising numeric symbol entry means and non-numeric symbol entry means coupled to a controller, said controller operating under control of a program to receive an entered non-numeric symbol and to convert the entered non-numeric symbol to a corresponding numeric symbol in accordance with a non-numeric symbol to numeric symbol mapping function, said controller having an output coupled to a telephone number dialer function for outputting the corresponding numeric symbol to the telephone number dialer function.

39. A user interface as in claim 38, where said numeric symbol entry means comprises one of a physical or a virtual telephone touch tone keypad comprising number keys, and where said non-numeric symbol entry means comprises one of a physical or a virtual keyboard comprising alphabetic letter keys.

40. A user interface as in claim 38, where at least one of said numeric symbol entry means and said non-numeric symbol entry means comprises a touch sensitive screen.

41. A user interface as in claim 38, where said numeric symbol entry means and said non-numeric symbol entry means both comprise the same touch sensitive screen.

42. A user interface as in claim 38, where at least one of said numeric symbol entry means and said non-numeric symbol entry means comprises a physical key-based entry device.

43. A user interface as in claim 38, where said numeric symbol entry means and said non-numeric symbol entry means both comprise the same physical key-based entry device.

44. A user interface as in claim 38, where said user interface comprises a part of a user terminal having a telephone functionality, where a telephone number is entered by a user as a combination of numbers and alphabetic characters, and where said telephone number dialer function outputs a string of numeric symbols to a telephone network operator.

45. A user interface as in claim 44, where the string of numeric symbols is sent to the telephone network operator using a wireless communication channel.

46. A user interface as in claim 38, further comprising means for displaying to a user entered numeric and non-numeric symbols.

47. A user interface as in claim 38, further comprising means for displaying to a user entered numeric symbols and corresponding numeric symbols output from the numeric symbol to non-numeric symbol mapping function.

48. A dialer user interface, comprising an input device coupled to a controller and operable to enter at least non-numeric symbols, said controller operable to convert an entered non-numeric symbol to a numeric symbol in accordance with a non-numeric symbol to numeric symbol mapping function to provide a telephone number to be dialed.

49. A dialer user interface, comprising an input device coupled to a controller and operable to enter at least non-numeric symbols, said controller operable to convert an entered non-numeric symbol to a numeric symbol in accordance with a non-numeric symbol to numeric symbol mapping function to provide at least a part of a telephone number.

50. A software product, comprising program instructions readable by a data processor and causing the data processor to implement a dialer user interface operable to receive at least non-numeric symbols and to convert a received non-numeric symbol to a numeric symbol in accordance with a non-numeric symbol to numeric symbol mapping function to provide at least a part of a telephone number.

51. A software product as in claim 50, where the non-numeric symbol to numeric symbol mapping function is one based on an ITU International Standard E. 161.

52. A software product as in claim 50, where the non-numeric symbol to numeric symbol mapping function is one based on a Mobile Phone Keypad.
